(19) United States
(12) Patent Application Publication
(10) Pub. No.: US 2021/0339844 A1
(43) Pub. Date: Nov. 4, 2021

(54) REAR END SECTION FOR AN AIRCRAFT

(71) Applicant: Airbus Operations S.L., GETAFE (ES)

(72) Inventor: Raul Carlos LLAMAS SANDIN, GETAFE (ES)

(21) Appl. No.: 17/241,579

(22) Filed: Apr. 27, 2021

(30) Foreign Application Priority Data
Apr. 29, 2020 (EP) 20382351.3

(51) Int. Cl. B64C 1/06; B64D 29/04; B64D 27/24; B64C 3/50; B64C 9/32

(52) U.S. Cl. CPC B64C 1/0685; B64D 29/04; B64D 27/24; B64C 2230/12; B64C 9/326; B64C 9/323; B64C 3/50

(57) ABSTRACT

A rear end section for an aircraft, having a fuselage, a v-tail, and a thruster assembly including at least one propulsion device installed to ingest and consume air forming a fuselage boundary layer, a control surface attached at the rearmost section of the rear end, and a casing covering at least part of the propulsion device such that an air inlet and an air outlet are defined between the casing and the propulsion device. The air inlet is configured to permit passage of the fuselage boundary layer towards the propulsion device. The air outlet is configured to direct the airflow exhausted from the propulsion device into the control surface, to divert the airflow and provide vectoring thrust for the aircraft.

### CROSS-REFERENCES TO RELATED APPLICATIONS

This application claims the benefit of the European patent application No. 20382351.3 filed on Apr. 29, 2020, the entire disclosures of which are incorporated herein by way of reference.

### FIELD OF THE INVENTION

The present invention refers to a rear end for an aircraft including a boundary layer ingestion (BLI) engine adapted to operate as a thruster with the aid of a movable control surface, mounted after the exhaust of the BLI engine to modulate the flow and divert it in order to provide vector thrust.

### BACKGROUND OF THE INVENTION

The NASA STARC-ABL aircraft concept has a Boundary Layer Ingestion propulsion, where a conventional small engine (electric or thermal) drives a fan or rotor located at the end of a conical aft fuselage. This aircraft concept exhibits a T-tail. The European version of this project, known as CENTRELINE, is almost identical to the STARC-ABL concept.

The NASA/MIT D8 aircraft exhibits a Boundary Layer Ingestion propulsive system on a flattened rear fuselage. In this case, the empennage is of a “Pi” tail configuration, and the engines installed at the rear end are primary propulsive engines installed to only ingest the boundary layer on the upper surface of the fuselage.

Regarding thrust vectoring, there are several concepts and applications known in the prior art but none of them is related to an engine that also operates as a BLI engine.

It would therefore be desirable to provide a technical solution that provides both an increase of the propulsive efficiency and thrust vectoring through the use of a BLI engine.

### SUMMARY OF THE INVENTION

The present invention overcomes the above mentioned drawbacks by providing a rear end section for an aircraft adapted to perform boundary layer ingestion at the time that provides vectoring thrust to the aircraft.

A main object of the present invention is to provide a rear end for an aircraft that is able of increasing the propulsive efficiency of conventional aircrafts, by ingesting the slow air in the fuselage boundary layer into some fluid mechanic thrusting devices, to increase the aircraft velocity, and reduce its usual energy consumption.

Another object of the invention is to reduce the size of the rear end of an aircraft.

The rear end section for an aircraft has a fuselage, a v-tail formed by two surfaces set in a v-shaped configuration, and a thruster assembly mounted on the rear end fuselage between the v-tail and the rearmost section of the rear end fuselage. The thruster assembly comprises at least one propulsion device installed to ingest the air from the boundary layer formed over the fuselage of the aircraft, a control surface attached at the rearmost section of the rear end, and a casing covering at least part of the propulsion device such that an air inlet and an air outlet are defined between the casing and the propulsion device. The air inlet is designed for the passage of the fuselage boundary layer towards the propulsion device, and the air outlet is designed for directing the airflow exhausted from the propulsion device towards the control surface, to divert the airflow in order to provide vectoring thrust for the aircraft.

The invention provides an aircraft rear end with a propulsion device (engine) operating both as a BLI engine, by ingesting and consuming air forming a boundary layer over the fuselage of the aircraft, and also as a vectoring thruster with the aid of a control surface mounted to receive the engine slipstream, blowing over the control surface.

The invention increases the propulsive efficiency of the aircraft, and thus decreases its fuel consumption. The increment in linear momentum of the air of the boundary layer effected by the BLI engine generates thrust, but the air in the slipstream has a lower velocity than it would be required to have in order to impart this momentum jump to free-stream air, thus leaving less kinetic energy in the slipstream and helping to reduce the energy consumption to generate a given amount of thrust.

Preferably, the at least one propulsion device will comprise an array of engines in order to improve the boundary layer capture efficiency, and to reduce the size and cost of each of the engines.

Additionally, using the BLI concept and adapting it to produce thrust vectoring, allows reducing the size of the empennage, with a consequent reduction of weight, drag and cost of the aircraft.

### BRIEF DESCRIPTION OF THE DRAWINGS

For a better comprehension of the invention, the following drawings are provided for illustrative and non-limiting purposes, wherein:

FIG. 1 shows a perspective view of the aircraft rear end section of the aircraft.

FIG. 2 shows an upper perspective view of the rear end section of the aircraft.

FIG. 3 shows a schematic longitudinal section view of the rear end section of the aircraft.

FIG. 4 shows a rear view of the rear end section of the aircraft.

### DETAILED DESCRIPTION OF THE PREFERRED EMBODIMENTS

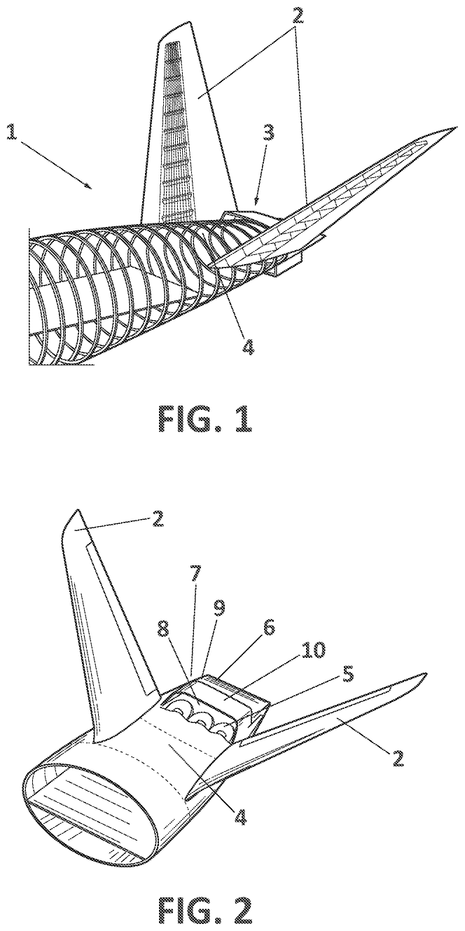

FIG. 1 shows a preferred embodiment of the proposed concept. A conventional fuselage is shaped so that its rear end fuselage (4) section has a flattened shape. A thruster assembly (3) is installed towards the end of the fuselage (4), between the fins of a v-tail (2) arrangement and the rearmost section of the rear end fuselage (4).

As seen in FIG. 2, the thruster assembly (3) comprises at least one propulsion device (5), a control surface (6), and a casing (7) defining an air inlet (8) and an air outlet (9) between the casing (7) and the propulsion device (5).

The propulsion device (5) is installed to ingest and consume air forming the fuselage boundary layer. The control surface (6) is mounted at the rearmost section of the rear end to receive the exhaust (outflow) of the propulsion device (5), and thus provide vectoring thrust to the aircraft when the control surface (6) is deflected. The casing (7) is designed to cover at least part of the propulsion device (5) to allow both the passage of the fuselage boundary layer towards the propulsion device (5) through the air inlet (8), and the passage of the airflow exhausted from the propulsion device (5) towards the control surface (6) through the air outlet (9).

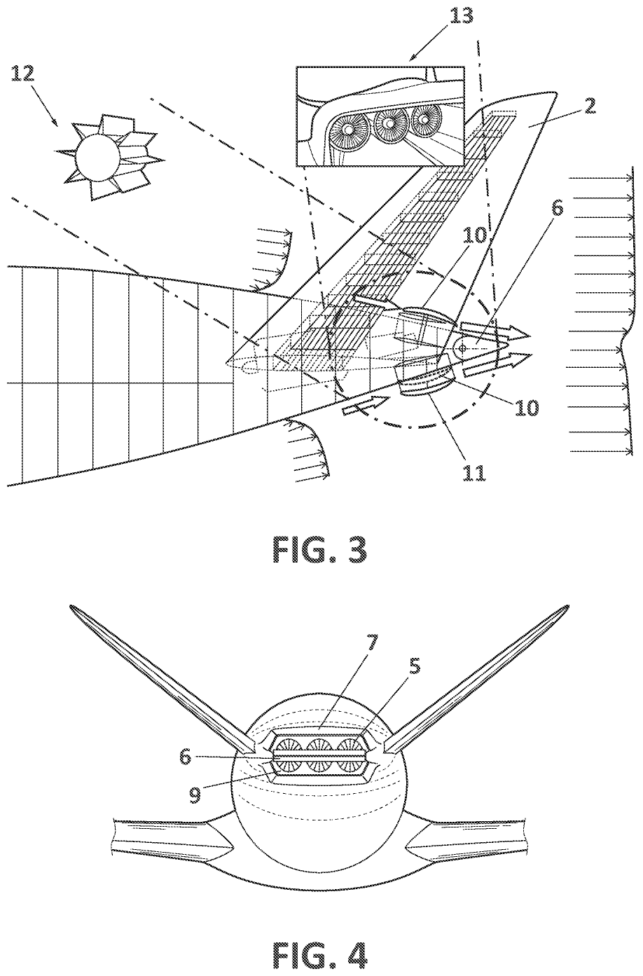

As shown in FIG. 3 and according to a preferred embodiment, the thruster assembly casing (7) has a main surface (10) substantially parallel to the aircraft fuselage (4), and the casing (7) further comprises at least one flap (11) movable between two extreme positions, a close position wherein the flap (11) is aligned with the main surface (10) of the casing (7), and an open position wherein the flap (11) is deflected, forming an angle with the main surface (10), to operate as an air-brake.

According to another preferred embodiment, the control surface (6) is rotatably attached to the rearmost section of the rear end to provide a pitching movement to the aircraft. The technical advantage of this vectored thrust is to reduce the size of the empennage.

Finally, as shown in FIGS. 2-4 and according to another preferred embodiment, the propulsion device (5) comprises an engine driving fluid mechanical devices, such as fans (13) or paddles (12), or electroaerodynamic devices, such as electromagnetic or plasma-dynamic actuators.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A rear end section for an aircraft, comprising:
a fuselage,
a v-tail configuration, and
a thruster assembly mounted on the rear end section fuselage between the v-tail configuration and the rearmost section of said rear end section fuselage, wherein the thruster assembly comprises:
at least one propulsion device installed to ingest and consume air forming a fuselage boundary layer,
a control surface attached at the rearmost section of the rear end section fuselage, and
a casing covering at least part of the propulsion device such that an air inlet and an air outlet are defined between the casing and the propulsion device, the air inlet being configured to allow a passage of the fuselage boundary layer towards the propulsion device, and the air outlet being configured to direct an airflow exhausted from the propulsion device towards the control surface to divert said airflow and provide vectoring thrust for the aircraft.

2. The rear end section for an aircraft, according to claim 1,
wherein the thruster assembly casing has a main surface substantially parallel to the rear end section fuselage, and
wherein the casing further comprises at least one flap movable between two extreme positions, a close position wherein the flap is aligned with the main surface of the casing, and an open position wherein the flap is deflected, forming an angle with said main surface, to operate as an air-brake.

3. The rear end section for an aircraft, according to claim 1, wherein the control surface is rotatably attached to a rearmost section of the rear end section to provide a pitching movement to the aircraft.

4. The rear end section for an aircraft, according to claim 1, wherein the propulsion device comprises engine driving fluid mechanical devices.

5. The rear end section for an aircraft according to claim 4, wherein the engine driving fluid mechanical devices comprise fans.

6. The rear end section for an aircraft according to claim 4, wherein the engine driving fluid mechanical devices comprise or paddles.

7. The rear end section for an aircraft according to claim 4, wherein the engine driving fluid mechanical devices comprise electroaerodynamic devices.

8. The rear end section for an aircraft according to claim 7, wherein the electroaerodynamic devices comprise electromagnetic actuators.

9. The rear end section for an aircraft according to claim 7, wherein the electroaerodynamic devices comprise plasma-dynamic actuators.
